(19) United States
(12) Patent Application Publication
(10) Pub. No.: US 2006/0077135 A1
(43) Pub. Date: Apr. 13, 2006

(54) Method for compensating an OLED device for aging

(75) Inventors: Ronald S. Cok, Rochester, NY (US); Felipe A. Leon, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/961,648

(22) Filed: Oct. 8, 2004

(51) Int. Cl. G09G 3/30

(52) U.S. Cl. 345/76

(57) ABSTRACT

A method for compensating an OLED device having one or more light emitting elements having an output that changes with time or use, comprising: a) driving the OLED device at a known drive signal, and measuring a first current used by the light emitting elements and a first light output produced by the OLED device at the known drive signal; b) driving the OLED device for a time period after step (a); c) driving the OLED device at the known drive signal after step (b), and measuring a second current used by the light emitting elements and a second light output produced by the OLED device at the known drive signal; d) determining an aging function based on the measured first and second currents, known drive signal, and first and second light outputs; e) driving the OLED device for a period of time after step (d); f) measuring a third current used by the light emitting elements at the known drive signal after step (e); g) calculating a correction factor for the OLED device to correct for change in light output of the OLED device using the aging function determined in step (d) and the third current measured in step (f); and h) applying the correction factor to a drive signal for the OLED device.

### FIELD OF THE INVENTION

The present invention relates to OLED devices and more particularly to a method for compensating for the aging of the organic light emitting device.

### BACKGROUND OF THE INVENTION

Solid-state organic light emitting diode (OLED) devices are of great interest as a superior flat-panel display technology. These devices utilize current passing through thin films of organic material to generate light. The color of light emitted and the efficiency of the energy conversion from current to light are determined by the composition of the organic thin-film material. Different organic materials emit different colors of light. However, as the device is used, the organic materials in the device age and become less efficient at emitting light thereby reducing the lifetime of the device. The differing organic materials may age at different rates, causing differential color aging and a device whose white point varies as the device is used.

Referring to FIG. 2, a graph illustrating the typical light output of a prior-art OLED device as current is passed through the OLEDs is shown. The three curves represent typical changes in performance of red, green and blue light emitters over time. As can be seen by the curves, the decay in luminance between the differently colored light emitters is different. Hence, in conventional use, with no aging correction, as current is applied to each of the differently colored OLEDs, the device will become less bright and the color, in particular the white point, of the device will shift.

A variety of means to correct for the changes in OLED efficiency and brightness over time are proposed in the art. One technique relies on sensing the light output by the device and compensating a driver in response. Luminance sensing can be done internally to an active-matrix pixel or externally on a more global basis. Such methods require the integration of optical sensors, greatly increases complexity, and reduces yields in a device. A second technique measures the performance of a proxy, for example an extra pixel element to estimate the aging of the OLED device. This approach has the disadvantage of assuming that the behavior of the proxy element is identical to that of the OLED itself. A third approach relies on measurement of current or voltage used within a pixel, but this approach requires additional circuitry in each pixel of an active-matrix device. A fourth technique relies upon measuring and integrating the current used by the OLED device over time. However, through experimentation, applicant has determined that the response and aging of OLED devices are too variable to provide a reliable correction using this method. It is also known to estimate the aging of an OLED device by employing a mathematical model. However, such models require assumptions about the consistency of a variety of OLED devices that is not found in actual experience. It is also known that the operational temperature of the OLED affects its rate of degradation.

As noted, the rate at which the device ages is related to the amount of current that passes through the device and, hence, the amount of light that has been emitted from the device. One technique to compensate for this aging effect in polymer light emitting diodes is described in U.S. Pat. No. 6,456,016 issued Sep. 24, 2002 to Sundahl et al. This approach relies on a controlled reduction of current provided at an early stage of device use followed by a second stage in which the device output is gradually decreased.

U.S. Pat. No. 6,414,661 B1 entitled “Method and apparatus for calibrating display devices and automatically compensating for loss in their efficiency over time” by Shen et al issued 20020702 describes a method and associated system that compensates for long-term variations in the light-emitting efficiency of individual organic light emitting diodes (OLEDs) in an OLED display device, calculates and predicts the decay in light output efficiency of each pixel based on the accumulated drive current applied to the pixel and derives a correction coefficient that is applied to the next drive current for each pixel. In one exemplary embodiment of the invention, the calculation is based on the accumulated current that has been passed through the device. In another exemplary embodiment, the calculation is based on a difference in voltage across the pixel at two instants.

These solutions require that the operating time of the device be tracked by a timer within the controller which then provides a compensating amount of current. Means to accumulate current applied to the device or to measure the instantaneous voltage applied to the device and associated memories require extensive timing, calculation, and storage circuitry in the controller. Also, this technique does not accommodate differences in behavior of the device at varying levels of brightness and temperature and cannot accommodate differential aging rates of the different organic materials. Moreover, this technique does not actually measure the performance of the OLED device in use so that unforeseen changes in operating conditions that may affect the OLED device performance are not accommodated.

U.S. patent application 2002/0167474 A1 by Everitt, published Nov. 14, 2002, describes a pulse width modulation driver for an organic light emitting diode display. One embodiment of a video display comprises a voltage driver for providing a selected voltage to drive an organic light emitting diode in a video display. The voltage driver may receive voltage information from a correction table that accounts for aging, column resistance, row resistance, and other diode characteristics. In one embodiment of the invention, the correction tables are calculated prior to and/or during normal circuit operation. Since the OLED output light level is assumed to be linear with respect to OLED current, the correction scheme is based on sending a known current through the OLED diode for a duration sufficiently long to allow the transients to settle out and then measuring the corresponding voltage with an analog to digital converter (A/D) residing on the column driver. A calibration current source and the A/D can be switched to any column through a switching matrix. This design requires the use of integrated, calibrated current source and A/D converter, greatly increasing the complexity of the circuit design.

U.S. Pat. No. 6,504,565 B1 issued Jan. 7, 203 to Narita et al., describes a light-emitting device which includes a light-emitting element array formed by arranging a plurality of light-emitting elements, a driving unit for driving the light-emitting element array to emit light from each of the light-emitting elements, a memory unit for storing the number of light emissions for each light-emitting element of the light-emitting element array, and a control unit for controlling the driving unit based on the information stored in the memory unit so that the amount of light emitted from each light-emitting element is held constant. An exposure device employing the light-emitting device, and an image forming apparatus employing the exposure device are also disclosed. This design requires the use of a calculation unit responsive to each signal sent to each pixel to record usage, greatly increasing the complexity of the circuit design.

JP 2002278514 A by Numeo Koji, published Sep. 27, 2002, describes a method in which a prescribed voltage is applied to organic EL elements by a current-measuring circuit and the current flows are measured; and a temperature measurement circuit estimates the temperature of the organic EL elements. A comparison is made with the voltage value applied to the elements, the flow of current values and the estimated temperature, the changes due to aging of similarly constituted elements determined beforehand, the changes due to aging in the current-luminance characteristics and the temperature at the time of the characteristics measurements for estimating the current-luminance characteristics of the elements. Then, the total sum of the amount of currents being supplied to the elements in the interval during which display data are displayed, is changed so as to obtain the luminance that is to be originally displayed, based on the estimated values of the current-luminance characteristics, the values of the current flowing in the elements, and the display data. This design presumes a predictable relative use of pixels and does not accommodate differences in actual usage of groups of pixels or of individual pixels. Hence, accurate correction for color or spatial groups is likely to be inaccurate over time. Moreover, the integration of temperature and multiple current sensing circuits within the display is required. This integration is complex, reduces manufacturing yields, and takes up space within the display.

US20020123291 A1 entitled “Manufacturing method of organic EL element” published 20020905 describes a manufacturing step for forming an organic EL element. The organic EL element is provided so as to have an anode and a cathode with a luminescent layer having an organic luminescent material interposed therebetween. Then, an aging treatment is performed. In the aging treatment, a curve of change in luminance with time is measured in driving the organic EL element at constant current. Then, the curve of change in luminance with time is divided into a component having a slowest luminance age-deterioration rate and other components by analyzing the curve and forming a fitting curve having a plurality of members that is fitted to the curve of change in luminance with time. Moreover, the aging treatment is conducted until a luminance of the element becomes approximately equal to an initial value A1 of the component having a slowest luminance age-deterioration rate. This technique provides a means to measure the material performance and therefore estimate future performance but does not provide a means of useful feedback in actual use.

All of the methods described above change the output of the OLED display to compensate for changes in the OLED light emitting elements. However, it is preferable that any changes made to the device be imperceptible to a user. Since devices are typically viewed in a single-stimulus environment, slow changes over time are acceptable, but large, noticeable changes are objectionable. Since continuous, real-time corrections are usually not practical because they interfere with the operation of the OLED device, most changes in OLED device compensation are done periodically. Hence, if an OLED device output changes significantly during a single period, a noticeably objectionable correction to the appearance of the device may result.

It is also true that in any real system, measurement anomalies may occur due to environmental or system perturbations or noise that do not reflect the actual situation. Corrections in response to such anomalies are undesirable and may result in damage to the system or may degrade device performance. Manufacturing processes used to make OLED devices also exhibit variability that affects the performance of the device and this manufacturing variability needs to be accommodated in any practical aging correction method.

Prior-art OLED systems incorporating aging or luminance compensation generally rely upon either a direct measurement of the OLED device performance (for example, the light output by the device) or a behavioral model of expected performance. However, direct measurement of the light output of the OLED device and of a performance attribute of the light emitting elements in the OLED device are difficult and expensive to make. On the other hand, behavioral models have only limited usefulness because of the variability of the OLED device performance. Applicants have determined through experimentation that a single model or measured performance attribute is inadequate for properly compensating declining OLED efficiency in a real manufacturing process. In particular, conventional manufacturing processes utilize large glass substrates that are subsequently singulated into smaller devices. The performance of the different singulated devices may be different due to variability in deposition uniformity of component layers thereby causing performance variability. The prior art methods discussed above are primarily directed towards performing uniformity corrections between individual pixels in a single device, and behavioral models of expected performance do not take into account global non-uniformities in performance between different singulated devices. Thus, some devices that are controlled by expected behavioral models and corrected as described in the prior art may still fail to meet performance:specifications.

It is also the case that some environmental factors, for example temperature of operation, length of operation, and time since previous operation all contribute to the efficiency of the device. It is difficult to accommodate all environmental factors in a correction scheme. Therefore, it is important to provide corrections that are robust in the face of unanticipated environmental variables. The methods shown in the prior art do not address these environmental variables.

There is a need therefore for an improved aging compensation method for organic light emitting diode devices.

### SUMMARY OF THE INVENTION

The need is met according to one embodiment of the present invention by providing a method for compensating an OLED device having one or more light emitting elements having an output that changes with time or use, comprising the steps of:

a) driving the OLED device at a known drive signal, measuring a first current used by the light emitting elements at the known drive signal, and measuring a first light output produced by the OLED device at the known drive signal;

b) driving the OLED device for a time period after step (a);

c) driving the OLED device at the known drive signal after step (b), measuring a second current used by the light emitting elements at the known drive signal, and measuring a second light output produced by the OLED device at the known drive signal;

d) determining an aging function based on the measured first and second currents, known drive signal, and first and second light outputs;

e) driving the OLED device for a period of time after step (d);

f) measuring a third current used by the light emitting elements at the known drive signal after step (e);

g) calculating a correction factor for the OLED device to correct for change in light output of the OLED device using the aging function determined in step (d) and the third current measured in step (f); and

h) applying the correction factor to a drive signal for the OLED device.

In a further embodiment of the invention, an OLED device having one or more light emitting elements having an output that changes with time or use is described, comprising:

a) a current measurement device for measuring a current used by the light emitting elements when driven by a known drive signal;

b) a circuit for determining a correction factor for a drive signal responsive to the measured current and an aging function stored in the circuit; and

c) a controller for applying the correction factor to an input signal and driving the OLED device with a corrected input signal to correct for change in light output of the OLED device.

### Advantages

The advantages of this invention are a method for operating an OLED device to compensate for reduced light emitting efficiency over time that accommodates manufacturing variability and environmental variability and provides a simple implementation.

### BRIEF DESCRIPTION OF THE DRAWINGS

FIG. 1 is a flow diagram of one embodiment of the present invention;

FIG. 2 is a diagram illustrating the aging of OLED devices;

FIG. 3 is a flowchart illustrating the use of the present invention; and

FIG. 4 is a schematic diagram of an OLED device according to one embodiment of the present invention.

### DETAILED DESCRIPTION OF THE INVENTION

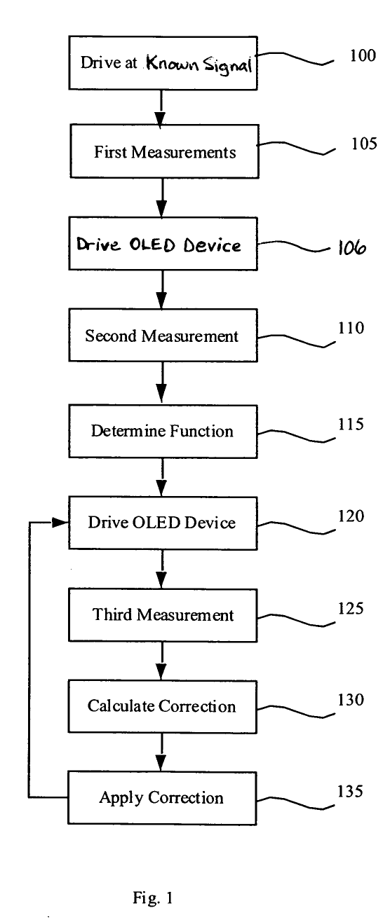

Referring to FIG. 1, a method of the present invention is illustrated in a flow diagram. According to one embodiment of the present invention, a method for compensating an OLED device having one or more light-emitting elements having an output that changes with time or use, comprises the steps of driving 100 the OLED device at a known drive signal; measuring 105 a first current used by the light emitting elements at the known drive signal, and measuring a first light output produced by the OLED device at the known drive signal; driving 106 the OLED device for a time period after the first measurements; driving the OLED device again at the known drive signal, and measuring 110 a second current used by the light emitting elements at the known drive signal and a second light output produced by the OLED device at the known drive signal; determining 115 an aging function based on the measured first and second currents, known drive signal, and first and second light outputs; driving 120 the light emitting elements for a period of time after the second measurements; measuring 125 a third current used by the light emitting elements at the known drive signal; calculating 130 a correction factor for the OLED device to correct for change in light output of the OLED device using the aging function and the third current; and applying 135 the correction factor to a drive signal for the OLED device.

The aging of the OLEDs is related to the cumulative current passed through the OLED resulting in reduced performance, also the aging of the OLED material results in an increase in the apparent resistance of the OLED that causes a decrease in the current passing through the OLED at a known drive signal. The decrease in current is directly related to the decrease in luminance of the OLED. In addition to the OLED resistance changing with use, the light emitting efficiency of the organic materials is reduced.

The present invention relies upon the relationship between the apparent resistance of the light emitting elements of the OLED and the decrease in luminance. Hence, unlike the prior art, no measurement of accumulated current is necessary and a measure of the decrease in OLED luminance may be made by an instantaneous measurement of the current passed through the OLED for a given drive signal. A variety of pixel circuits are known which can supply a current to the OLED in response to a known signal, for example, voltage driven circuits may be employed. Current is typically supplied to all of the light emitting elements in an OLED through a common power signal passed through a driving transistor circuit from a power signal to a common ground; the current passing from the power circuit to a ground may be measured to provide an instantaneous measure of the current passing through all of the light emitting element of the OLED at once. Hence, no measurement of the individual current or voltage drop across any single light emitting element is necessary.

The initial steps of the method constitute a calibration process. Driving the OLED light-emitting elements at a known drive signal at two separated instances separated by a period of use (where the light output by the OLED device will become less due to aging) enables an initial calibration of the OLED device performance and rate of aging. The known drive signal may result in a given voltage, such as may be associated with a flat field of constant luminance across the light emitting elements in the device. By measuring the current used at the given voltage and the light output at the two separated instances, the OLED device may be characterized and the relationship between the apparent resistance of the OLED device and luminance may be determined. These two measurements of current, and light output together with the known given voltage provide data used to predict the further degradation of the device luminance as it is used with respect to resistance changes. In particular, through performance measurements of existing OLED devices during the device's lifetime, applicants have empirically determined a relationship between the ratio of the current and the light output from the OLED that can be used to calculate the additional current necessary to correct the light output from the OLED device. While the initial calibration process described above may be performed with a minimum of two measurements, additional measurements may be made to further define the relationship between apparent resistance and luminance of the light emitting elements of the OLED device. Alternatively, the light output may be measured and the calibration process continued until the light output has decreased by a fixed, pre-determined amount (for example 10%). After the light output has decreased by the pre-determined amount, the current and voltage values may be measured and the degradation rate for the OLED device determined. The more defined the relationship is, the more accurately luminance can be corrected in the presence of manufacturing variability that may affect the brightness and aging characteristics of OLEDs on a device to device basis.

In an alternative embodiment, the performance of the OLED device may be measured at a plurality of brightness levels, thereby providing additional data about the aging characteristics of the OLED device. Separate correction factors may be calculated for each brightness level enabling more accurate correction across a wider range of light levels. Separate correction factors for operation at brightness levels other than those measured may be obtained by interpolating between the correction factors for the measurements made.

In experiments performed by applicants, it has been found that the relationship between changes in apparent resistance and luminance of the light emitting elements of an OLED device is generally consistent for individual light emitting elements of an OLED device. Due to manufacturing variability, however, the initial luminance of an OLED device may be independent of the initial apparent resistance so that a calibration as described above is necessary for providing accurate compensation. This calibration is best done in a manufactory, since it requires a measurement of not only the current and voltage used to drive the OLED device, but also the light output. Such measurements can readily be made using conventional electrical test equipment and light measurement devices, for example, photometers and digital cameras, as are known in the art. The current measurement device can comprise, for example, a resistor connected across the terminals of an operational amplifier as is known in the art.

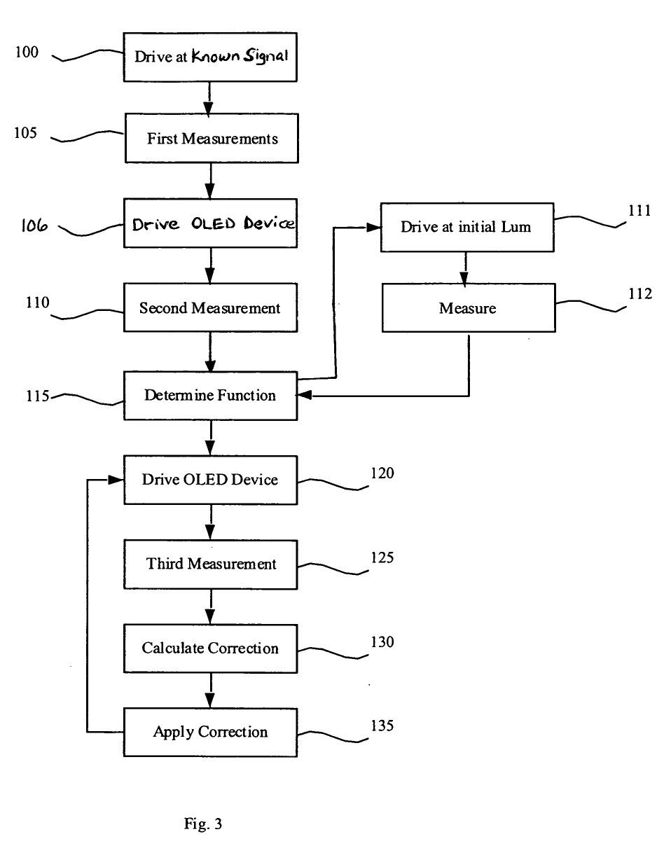

Referring to FIG. 3, in an enhanced implementation of the present invention, the calibration step can include the additional step of driving 111 the OLED device after an initial function is determined (based on the first and second measurements) to the measured first light output level by applying a corrected drive signal. The performance of the OLED in response to the corrected drive signal is measured 112. If the output is correct, a final function is defined and the device put into use. If not, the cycle may be repeated. An explicit calibration measurement of an initial correction removes unwanted noise factors from a calculation based on a theoretical model.

Once the device is calibrated and the degradation rate and output efficiency determined, the device may be used and applied by a user at a variety of voltage levels for any desired length of time. At the end of a time period, the OLED device may again be driven at the known signal and the current used by the device measured. Using the relationship established previously and the current measurement, a correction factor may be calculated and used to correct the light output of the device. The OLED device may then be placed into service again and applied by a user as before for any desired length of time, after which the current measurement process and correction may be repeated. The correction itself may be applied by increasing the voltage or current supplied to the OLED device. Because no measurement of the light output is necessary at this stage, the correction factor can be calculated without recourse to additional equipment.

It is possible to employ the present invention to achieve an improved color balance of a color OLED device during its life. The calibration and correction process described above may be employed for each group of light emitting elements of a common color. Since the degradation characteristics of an OLED light emitter depend on the light emitting material, and since different materials may be employed to produce different colors of light, the colors in a color OLED will age at different rates. By correcting for each color separately with separate correction factors, the present invention can maintain a consistent color balance or white point for the OLED device.

Different corrections may be applied separately to different groups of OLED light emitting elements depending on their location on the OLED device as well as depending on their color. For example, variable OLED manufacturing processes can produce performance variability in an OLED device that are dependent on rows or columns in an array of light emitting elements. By grouping the light emitting elements into rows and/or columns and calculating and applying different corrections to the rows and/or columns, row or column aging-related characteristics may be compensated. Alternatively, the groups may include groups that are defined by their location on the device, for example, icons made up of neighboring pixels in a device.

In one embodiment, the OLED device is a color image display comprising an array of pixels, each pixel including a plurality of different colored light emitting elements (e.g. red, green and blue) that are individually controlled by a controller circuit to display a color image. The colored light emitting elements may be formed by different organic light emitting materials that emit light of different colors, alternatively, they may all be formed by the same organic white light emitting materials with color filters over the individual elements to produce the different colors. In another embodiment, the light emitting elements are individual graphic elements within a display and may not be organized as an array. In either embodiment, the light emitting elements may have either passive- or active-matrix control and may either have a bottom-emitting or top-emitting architecture.

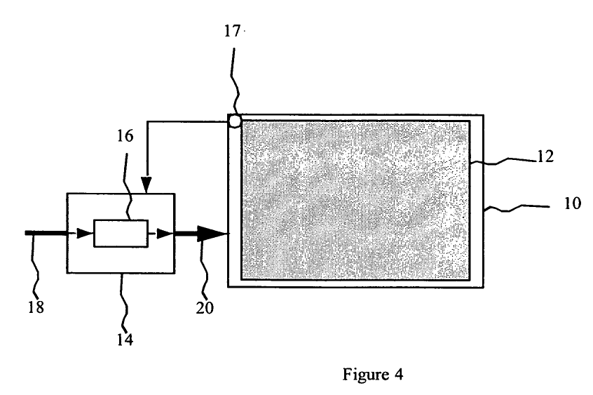

Referring to FIG. 4, an OLED device and controller may include an OLED device 10 having light emitting elements 12 and controller 14. The measurements and calculations described above may be performed by external measurement and computing equipment or may be incorporated into the controller 14 and/or OLED device 10. In operation, an input image signal 18 is applied to the controller 14. The controller 14 corrects the input image signal for each group of light emitting elements using a computational or lookup table circuit 16 to form a corrected input image signal 20 that is applied to the OLED device 10 and the process repeats. Periodically, a new correction factor for the OLED device is calculated. The OLED device 10 is removed from use, the known signal is reapplied to each group of light emitting elements, and a measurement of the OLED device current taken again. Corrections may then be calculated and stored in the lookup circuit 16. The process may be repeated for each group of light emitting elements. The device is then returned to use so that as each new input image signal 18 is applied, the controller forms a new corrected image signal 20 and applies the corrected image signal to the device.

The corrected control signal may take a variety of forms depending on the OLED device. For example, if analog voltage levels are used to drive the OLEDs, the correction will modify the voltages of the control signal. This can be done using amplifiers as is known in the art. In a second example, if digital values are used, for example corresponding to a charge deposited at an active-matrix pixel location, a lookup table may be used to convert the digital value to another digital value as is well known in the art. In a typical OLED device, either digital or video signals are used to drive the device. The actual OLEDs may be either voltage- or current-driven depending on the circuit used to pass current through the OLED.

Over time the OLED materials will age, the resistance of the OLEDs increase, and the correction will increase. At some point in time, the controller circuit 16 will no longer be able to provide an image signal correction 20 that is large enough and the OLED device 10 will have reached the end of its lifetime and can no longer meet its brightness or color specification. However, the device will continue to operate as its performance declines, thus providing a graceful degradation. Moreover, the time at which the device can no longer meet its specification can be signaled to a user of the device when a maximum correction is calculated, providing useful feedback on the performance of the device.

The present invention can be constructed simply, requiring only (in addition to a conventional OLED device controller) a current measurement circuit, a transformation means to perform the image signal correction (for example a lookup table or amplifier), and a calculation circuit to determine the correction for the given image signal. No current accumulation or time information is necessary. Although the device must be periodically removed from use to perform the correction, the period may be quite large, for example days or tens of hours of use. Initial calibration equipment is likewise simple, requiring only a measurement of the OLED device light output.

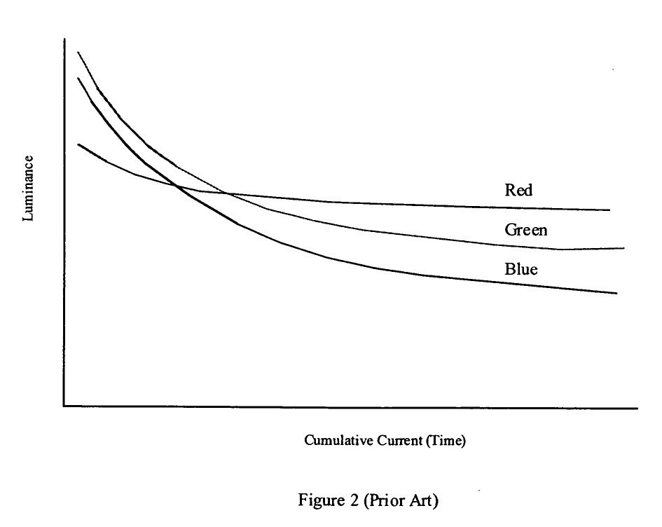

The present invention can be used to correct for changes in color of a color display. As noted in reference to FIG. 2, as current passes through the various light emitting elements in the OLEDs, the materials for each color emitter will age differently. By creating groups comprising all of the light emitting elements of a given color, and measuring the current used by the display for that group, a correction for the light emitting elements of the given color can be calculated. A separate correction factor may be applied for each color, thus maintaining a consistent color for the display device. In this case, the given input image signals may be flat, uniform fields for each individual color corresponding to the OLED materials that emit the corresponding color. This technique will work for both OLED devices that rely on emitters of different colors, or on a single, white emitter together with color filter arrays arranged to provide colored light emitting elements. In the latter case, the correction curves representing the loss of efficiency for each color are identical. However, the use of the colors may not be the same, so that a separate correction for each color is still necessary to maintain a constant luminance and display white point.

The present invention may be extended to include complex relationships between the corrected image signal, the measured current, and the aging of the materials. Multiple drive signals may be used corresponding to a variety of device outputs. For example, a different drive signal may correspond to each device output brightness level. When periodically calculating the correction signals, a separate correction signal may be obtained for each device output brightness level by using different given drive signals. A separate correction signal is then employed for each device output brightness level required. As before, this can be done for each light emitting element grouping, for example different light emitting element color groups. Hence, the correction signals may correct for each device output brightness level of the device for each color as each material ages.

The groups of light emitting elements and drive signals used to calculate the correction factors for the device may also be spatially specific as well as color specific. In this way, the correction signals may apply to specific light emitting elements so that if a subset of light emitting elements age more rapidly, for example, if they are used more heavily (as an icon in a graphic user interface might), they may be corrected differently from other light emitting elements. Therefore, the present invention may correct for the aging of groups of spatially distinct light emitting elements, and/or groups of colored light emitting elements. It is only necessary that a correction model be empirically derived for aging of each type of light emitting element or group of light emitting elements and that a periodic correction signal calculation be performed by driving the group of light emitting elements to be corrected.

The correction calculation process may be performed periodically during use, at power-up or power-down. The correction calculation process may take only a few milliseconds so that the effect on any user is limited. Alternatively, the correction calculation process may be performed in response to a user signal supplied to the controller.

OLED devices dissipate significant amounts of heat and become quite hot when used over long periods of time. Further experiments by applicant have determined that there is a strong relationship between temperature and current used by the device. Therefore, if the device has been in use for a period of time, the temperature of the device may need to be taken into account in calculating the correction signal. If it is assumed that the device has not been in use, or if the device is cooled, it may be assumed that the device is at a pre-determined ambient temperature, for example room temperature. If the correction signal model was determined at that temperature, the temperature relationship may be ignored. If the device is calibrated at power-up and the correction signal model was determined at ambient temperature, this is a reasonable assumption in most cases. For example, mobile devices with a relatively frequent and short usage profile might not need temperature correction. Device applications for which the device is continuously on for longer periods, for example, monitors or televisions, might require temperature accommodation, or can be corrected on power-up to avoid device temperature issues.

If the device is calibrated at power-down, the device may be significantly hotter than the ambient temperature and it is preferred to accommodate the calibration by including the temperature effect. This can be done by measuring the temperature of the device, for example with a thermocouple placed on the substrate or cover of the device, or a temperature sensing element, such as a thermocouple 17 (see FIG. 4), integrated into the electronics of the device. For devices that are constantly in use, the device is likely to be operated significantly above ambient temperature and the temperature can be taken into account for the device calibration.

To further reduce the possibility of complications resulting from inaccurate current readings or inadequately compensated device temperature, changes to the correction signals applied to the input image signals may be limited by the controller. Any change in correction can be limited in magnitude, for example to a 5% change. A calculated correction signal might also be restricted to be monotonically increasing, since the aging process does not reverse. Correction changes can also be averaged over time, for example an indicated correction change can be averaged with the previous value(s) to reduce variability. Alternatively, an actual correction can be made only after taking several readings, for example, every time the device is powered on, a corrections calculation is performed and a number of calculated correction signals (e.g. 10) are averaged to produce the actual correction signal that is applied to the device.

The correction signals used to modify the input image signal to form a corrected image signal may be used to implement a wide variety of device performance attributes over time. For example, the model used to supply correction signals to an input image signal may hold the average luminance or white point of the device constant. Alternatively, the correction signals used to create the corrected image signal may allow the average luminance to degrade more slowly than it would otherwise due to aging.

Once the correction is applied, the cycle is complete. After some period the cycle repeats. The period can be defined in a variety of ways, for example by time of use or by events such as power-up or power-down. Over time the correction applied will accommodate the device aging but in circumstances where the device ages very rapidly, the accommodation may take several cycles to fully accommodate the device aging. Since a long period of use may occur between the correction cycles described in FIG. 1, perceptible aging may occur in a device before a new correction value is applied. However, because the aging is gradual and viewing of the device generally takes place in a single stimulus context, it is not likely that the aging of the device will be noticed by a user. If a large correction is applied all at once, the correction may be perceptible to a user. Moreover, a correction based on an anomalous or incorrect measurement due to environmental factors or noise may cause damage or inhibit proper performance of a device. The present invention provides a slowly varying aging correction that will be robust in the presence of noisy measurements and will be imperceptible to a user under a wide variety of environmental circumstances.

A variety of restrictions on changes in correction signal values may be used. For example, the changes may be restricted to monotonically increasing corrections. Since aging in a device increases over time, restricting the changes in correction to a positive value at a variety of rates depending on the usage of the device provides a robust limit on the correction values. This can be important because noisy feedback values from the devices can appear to indicate that the device aging has been reversed. For example, the light output by a device depends on the current passed through the OLED light emitting elements in the device but also depends on the temperature of the OLED elements. If an initial measurement is made at a higher temperature and a subsequent measurement is made at a lower temperature, the efficiency of the device light emitting elements may appear to increase. If a correction value is then reduced to accommodate the apparent increase in device efficiency and the device is then used in a hot environment, the device will not be as bright as intended. This can occur not only by exposure to a variety of external temperatures but by measuring the feedback value at different times during the use of the device. Typically, the device is at room temperature when first turned on. The device then heats up as it is used and the length of time the device is used and the type of content shown on the device markedly affect the temperature of the device and the value of the feedback signals.

Another restriction that may be applied is the magnitude of the change in aging correction parameters. A user may choose to use a device for a long time. If the aging correction cycle is predicated on a usage parameter such as power-up or power-down, significant aging may occur during a single period of use. Because the aging is gradual, it may not be noticeable to the user, particularly because she may have no external comparison reference. However, if a correction to the aging is made all at once, the change may be noticeable, particularly if the change is made during use. By restricting the magnitude of the change to a fixed percentage, for example five percent, the change may be made imperceptible to the user.

Using the present invention, the restriction on corrections can be changed over time. For example, the rate of change in aging of an OLED device tends to decrease over time. Accordingly, the restrictions on the changes in the correction signal can be less during the early portion of the OLED device lifetime and greater during the latter portion of the lifetime of the device. It is also possible to reduce the frequency of corrections as the rate of change in aging of the device decreases during the lifetime of the device.

Another problem that can be encountered when measuring and analyzing the performance of a device is the phenomenon of charge trapping. In normal use, OLED devices may become less efficient due to charge trapping in the organic layers employed to emit light. After some time in an off state, the charges are relinquished and the efficiency of the device improves. If measurements of the device are taken when no charge trapping is present but the device was previously measured and is operated when charges are trapped, an inappropriately optimistic measurement and performance correction will result. Restricting the correction to a monotonically increasing value will inhibit inappropriate corrections of this sort.

The present invention can be employed in most top- or bottom-emitting OLED device configurations. These include simple structures comprising a separate anode and cathode per OLED and more complex structures, such as passive matrix devices having orthogonal arrays of anodes and cathodes to form pixels, and -active matrix devices where each pixel is controlled independently, for example, with a thin film transistor (TFT). As is well known in the art, OLED devices and light emitting layers include multiple organic layers, including hole and electron transporting and injecting layers, and emissive layers. Such configurations are included within this invention.

In a preferred embodiment, the invention is employed in a device that includes Organic Light Emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting devices can be used to fabricate such a device.

The invention has been described in detail with particular reference to certain preferred embodiments thereof, but it will be understood that variations and modifications can be effected within the spirit and scope of the invention.

### PARTS LIST

10 OLED device
12 light emitting elements
14 controller
16 look up table
17 temperature sensor
18 input image signal
20 corrected input image signal
100 drive step
105 measure step
106 drive step
110 measure step
111 drive step
112 measure step
115 determine function step
120 drive step
125 measure step
130 calculate correction step
135 apply correction step

1. A method for compensating an OLED device having one or more light emitting elements having an output that changes with time or use, comprising the steps of:
a) driving the OLED device at a known drive signal, measuring a first current used by the light emitting elements at the known drive signal, and measuring a first light output produced by the OLED device at the known drive signal;
b) driving the OLED device for a time period after step (a);
c) driving the OLED device at the known drive signal after step (b), measuring a second current used by the light emitting elements at the known drive signal, and measuring a second light output produced by the OLED device at the known drive signal;
d) determining an aging function based on the measured first and second currents, known drive signal, and first and second light outputs;
e) driving the OLED device for a period of time after step (d);
f) measuring a third current used by the light emitting elements at the known drive signal after step (e);
g) calculating a correction factor for the OLED device to correct for change in light output of the OLED device using the aging function determined in step (d) and the third current measured in step (f); and
h) applying the correction factor to a drive signal for the OLED device.

2. The method claimed in claim 1, wherein the OLED device has a plurality of light emitting elements and the known drive signal illuminates all of the light emitting elements of the OLED device.

3. The method claimed in claim 1, wherein the OLED device has a plurality of light emitting elements comprising light emitting elements that emit light of different colors, and wherein the light emitting elements of one color are illuminated separately from the light emitting elements of a different color and a separate correction factor is calculated and applied for each color of light emitting elements.

4. The method claimed in claim 1, wherein the OLED device has a plurality of light emitting elements divided into at least two groups of light emitting elements defined by their location on the device, and wherein the light emitting elements of one group are illuminated separately from the light emitting elements of a different group and a separate correction factor is calculated and applied for each group of light emitting elements.

5. The method claimed in claim 4, wherein the groups are defined by rows or columns of light emitting elements.

6. The method claimed in claim 1, wherein the correction factor is applied with a lookup table.

7. The method claimed in claim 1, wherein the OLED device is driven with known signals at a plurality of brightness levels and a separate correction factor is calculated for each brightness level.

8. The method claimed in claim 7, wherein three or four brightness levels are employed.

9. The method claimed in claim 7, further comprising interpolating additional correction factors from the calculated separate correction factors.

10. The method claimed in claim 1, wherein the output of the light emitting elements change with temperature, and further comprising modifying the correction factor based on the temperature.

11. The method claimed in claim 1, wherein steps (a)-(d) are performed before the OLED device is put into service.

12. The method claimed in claim 1, further comprising repeating steps (e)-(h) one or more times to recalculate and apply one or more new correction factors.

13. The method claimed in claim 12, wherein new correction factors are restricted to be monotonically increasing.

14. The method claimed in claim 12, wherein a change in a new calculated correction factor from a previously calculated correction factor is limited to a pre-determined maximum change.

15. The method claimed in claim 12, wherein new correction factors are applied to maintain a constant average luminance output for the OLED device over its lifetime.

16. The method claimed in claim 12, wherein an average correction factor is calculated as the average of a number of correction factor calculations taken over time.

17. The method claimed in claim 12, wherein the third current measurement is performed periodically, at power-up, or at power-down.

18. The method claimed in claim 1, wherein the correction factor is calculated to maintain a decreasing level of luminance over the lifetime of the device, but at a rate slower than that of an uncorrected device.

19. The method claimed in claim 1, wherein the correction factor is calculated to maintain a constant white point for the OLED device over its lifetime.

20. The method claimed in claim 1, further comprising the step of providing an end-of-life signal when the calculated correction factor exceeds a predetermined level.

21. An OLED device having one or more light emitting elements having an output that changes with time or use, comprising:
a) a current measurement device for measuring a current used by the light emitting elements when driven by a known drive signal;
b) a circuit for determining a correction factor for a drive signal responsive to the measured current and an aging function stored in the circuit;
c) a controller for applying the correction factor to an input signal and driving the OLED device with a corrected input signal to correct for change in light output of the OLED device.

22. The OLED device claimed in claim 21, further comprising a temperature measurement device.
